(19) United States
(12) Patent Application Publication
(10) Pub. No.: US 2013/0119191 A1
(43) Pub. Date: May 16, 2013

(54) LOAD-BEARING STRUCTURES FOR AIRCRAFT ENGINES AND PROCESSES THEREFOR

(71) Applicants: Jared Matthew Wolfe, Monroe, OH (US); James Michael Kostka, Cincinnati, OH (US)

(72) Inventors: Jared Matthew Wolfe, Monroe, OH (US); James Michael Kostka, Cincinnati, OH (US)

(73) Assignee: GENERAL ELECTRIC COMPANY, Schenectady, NY (US)

(21) Appl. No.: 13/293,677

(22) Filed: Nov. 10, 2011

(51) Int. Cl. B64D 27/26; B64D 27/00; F16M 13/00

(52) U.S. Cl. 244/54; 248/554

(57) ABSTRACT

Load-bearing structures constructed from polymer matrix composite (PMC) materials, and processes for their production. The structures are produced from at least one shaped panel formed of a continuous fiber reinforcement in a thermoplastic resin matrix. The shaped panel has been thermoformed to have a substantially constant cross-sectional thickness and portions that lie in different planes and are interconnected by one or more bends. The shaped panel is machined to alter its shape, and optionally to produce multiple separate subcomponents therefrom. The machined shaped panel can constitute the entire structure, or the structure can be formed by joining the machined shaped panel with other shaped panels or by joining two or more of the subcomponents. The structure can be installed on an aircraft engine to secure components to the engine.

### BACKGROUND OF THE INVENTION

The present invention generally relates to load-bearing structures and to processes for their production. More particularly, this invention is directed to the use of composite materials in the fabrication of load-bearing structures, as an example, brackets used in aircraft engines.

The maturation of composite technologies has increased the opportunities for the use of composite materials in a wide variety of applications, including but not limited to aircraft engines such as the GE90® and GEnx® commercial engines manufactured by the General Electric Company. Historically, the fabrication of components from composite materials has been driven by the desire to reduce weight, though increases in metal costs have also become a driving factor for some applications.

Composite materials generally comprise a fibrous reinforcement material embedded in a matrix material, such as a polymer or ceramic material. The reinforcement material serves as the load-bearing constituent of the composite material, while the matrix material protects the reinforcement material, maintains the orientation of its fibers and serves to dissipate loads to the reinforcement material. Polymer matrix composite (PMC) materials are typically fabricated by impregnating a fabric with a resin, followed by curing or solidification of the resin. Resins for matrix materials of PMCs can be generally classified as thermosets or thermoplastics. Thermoplastic resins are generally categorized as polymers that can be repeatedly softened and flowed when heated and hardened when sufficiently cooled due to a physical rather than chemical change. Notable example classes of thermoplastic resins include nylons, thermoplastic polyesters, polyaryletherketones, and polycarbonate resins. Specific examples of high performance thermoplastic resins that have been contemplated for use in aerospace applications include, polyetheretherketone (PEEK), polyetherketoneketone (PEKK), polyetherimide (PEI) and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy and polyester resins. A variety of fibrous reinforcement materials have been used in PMCs, for example, carbon (e.g., AS4), glass (e.g., S2), polymer (e.g., Kevlar®), ceramic (e.g., Nextel®) and metal fibers. Fibrous reinforcement materials can be used in the form of relatively short chopped fibers or long continuous fibers, the latter of which are often used to produce a “dry” fabric or mat. PMC materials can be produced by dispersing short fibers in a matrix material, or impregnating one or more fiber layers (plies) of dry fabrics with a matrix material.

Whether a PMC material is suitable for a given application depends on its matrix and reinforcement materials, the requirements of the particular application, and the feasibility of fabricating a PMC article having the required geometry. Due to their considerable potential for weight savings, various applications have been explored for PMCs in aircraft gas turbine engines. However, a challenge has been the identification of material systems that have acceptable properties yet can be produced by manufacturing methods to yield a cost-effective PMC component. In particular, it is well known that aircraft engine applications have high performance mechanical requirements, for example, strength and fatigue properties (necessitated by vibrations in the engine environment), as well as high temperature properties, chemical/fluid resistance, etc. Though considerable weight savings could be realized by fabricating aircraft engine brackets from PMC materials, performance requirements as well as the size, variability and complexity of such brackets have complicated the ability to cost-effectively produce brackets from these materials. For example, the use of traditional thermoset resins to produce PMC brackets has been generally viewed as cost prohibitive due to the labor-intensive process and long manufacturing cycle times involved with thermosets, as well as the large number of relatively small brackets having many different part configurations. On the other hand, PMCs formed with thermoplastic matrix materials are limited by their tendency to soften and lose strength at elevated temperatures.

Another complication is the type of reinforcement system required by PMC materials in aircraft engine applications. Generally, to realize a significant level of weight savings through the use of thermoset or thermoplastic PMC materials, brackets would require the use of continuous fiber-reinforced PMC materials to enable their cross-sections to be minimized while simultaneously achieving the high performance mechanical requirements (particularly strength and fatigue properties) dictated by aircraft engine applications. However, hand lay-up processes involved in the use of continuous fiber reinforcement materials further complicate the ability to produce a wide variety of relatively small brackets having complex shapes. On the other hand, chopped fiber reinforcement systems, whether in a thermoplastic or thermoset resin matrix, are not an ideal solution due to their lower mechanical performance. In particular, the lower strength of PMC components reinforced with chopped fibers necessitates the fabrication of a relatively thick and heavy bracket. Furthermore, chopped fiber systems are often processed using net shape molding methods, which enable complex shapes to be formed. However, because there is a large number of brackets that have different shapes on aircraft engines, the tooling cost associated with an individual mold being required for each unique bracket generally prohibits this manufacturing approach.

### BRIEF DESCRIPTION OF THE INVENTION

The present invention provides load-bearing structures constructed from PMC materials, and processes for their production. Notable but nonlimiting examples of such structures include the various types of brackets used in aircraft engines that can have relatively complex shapes.

According to a first aspect of the invention, a process of fabricating a load-bearing structure includes producing at least a first shaped panel that has a substantially constant cross-sectional thickness and has at least first and second portions that lie in different planes and are interconnected by at least a first bend therebetween. The first shaped panel is formed by thermoforming a polymer matrix composite material comprising a thermoplastic resin reinforced with a continuous fiber reinforcement material. The first shaped panel is then machined to alter its shape. The machining step may directly produce the load-bearing bracket from the first shaped panel. Alternatively, the machining step may produce at least a first subcomponent from the first shaped panel, and the process further entails a joining operation with the result that the first subcomponent forms part of the load-bearing bracket. Yet another alternative is for the machining step to produce multiple separate subcomponents from the first shaped panel, at least some of which then undergo a joining operation to form the load-bearing bracket. The resulting bracket can then be installed on an aircraft engine to secure a component to the aircraft engine.

A second aspect of the invention is a process that includes producing at least first and second flat panels of a polymer matrix composite material comprising a thermoplastic resin reinforced with a continuous fiber reinforcement material, in which each of the flat panels has a substantially constant cross-sectional thickness and is flat so as to lie in a single plane. At least one of the flat panels is then thermoformed to form at least a first shaped panel having a substantially constant cross-sectional thickness and having at least first and second portions that lie in different planes and are interconnected by at least a first bend therebetween. The first shaped panel is then machined to alter its shape and produce at least a first subcomponent therefrom. A load-bearing bracket is then produced by joining the first subcomponent to a second subcomponent defined by the second flat panel or a second shaped panel produced by thermoforming the second flat panel, after which the load-bearing bracket can be installed on an aircraft engine to secure a component to the aircraft engine.

Additional aspects of the invention include load-bearing brackets that are produced by the steps of one of the processes described above. However, more generally, the invention broadly encompasses aircraft engine brackets that are formed of a polymer matrix composite material that comprises a continuous fiber reinforcement material in a thermoplastic resin matrix material. As a more particular example, such an aircraft engine bracket includes at least first and second subcomponents that are joined together to form the bracket. Each subcomponent is formed of a polymer matrix material comprising a continuous fiber reinforcement material in a thermoplastic resin matrix material, and each subcomponent has a substantially constant cross-sectional thickness. At least one of the subcomponents is machined from at least one shaped panel that was thermoformed to have at least first and second portions that lie in different planes and are interconnected by at least a first bend therebetween.

A significant advantage of this invention is the ability to produce and utilize a load-bearing structure in applications such as aircraft engines, which greatly benefit from weight savings but simultaneously have demanding mechanical and environmental conditions. The invention enables the fabrication and use of thermoplastic PMC materials in a manner that manufacturing and materials costs and/or weight can be minimized without compromising the load-bearing functionality of the structure.

Other aspects and advantages of this invention will be better appreciated from the following detailed description.

### BRIEF DESCRIPTION OF THE DRAWINGS

FIG. 1 contains a scanned image that shows three shaped PMC panels that were thermoformed from flat PMC panels in accordance with certain embodiments of the invention.

FIG. 2 contains a scanned image that shows two subcomponents machined from shaped panels that underwent thermoforming similar to the shaped panels shown in FIG. 1.

FIG. 3 schematically represents a perspective view of subcomponents of types corresponding to the subcomponents represented in FIG. 2, and FIG. 4 schematically represents a perspective view of a bracket assembly formed by mechanically fastening together the subcomponents of FIG. 3.

FIG. 5 schematically represents a perspective view of a flat panel of a type that can be used to produced the shaped panels of FIG. 1 and the subcomponents represented in FIGS. 2, 3 and 4.

FIG. 6 schematically represents a perspective view of a shaped panel of a type that can be used to produced the three smaller subcomponents represented in FIGS. 3 and 4.

FIG. 7 schematically represents a perspective view of a bracket assembly formed by thermoplastically welding together the subcomponents of FIG. 3.

### DETAILED DESCRIPTION OF THE INVENTION

The present invention will be described in terms of composite load-bearing structures that, though capable of being adapted for use in a wide range of applications, are particularly well suited as brackets whose primary purpose is to support or secure various components of aircraft engines, for example, components within the fan sections of high-bypass gas turbine engines. Particularly notable examples are brackets that are mounted on the exterior of the fan case and support components such as tubes, wiring harnesses, oil tanks, etc. However, various other load-bearing structures and various other applications to which the present invention could be applied are also within the scope of the invention.

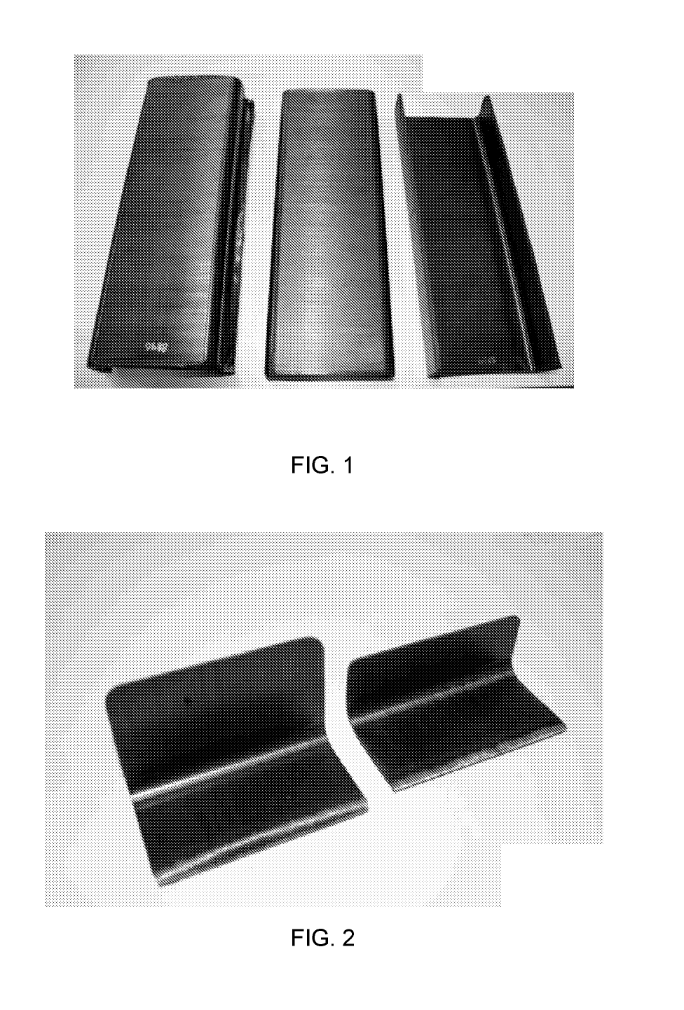

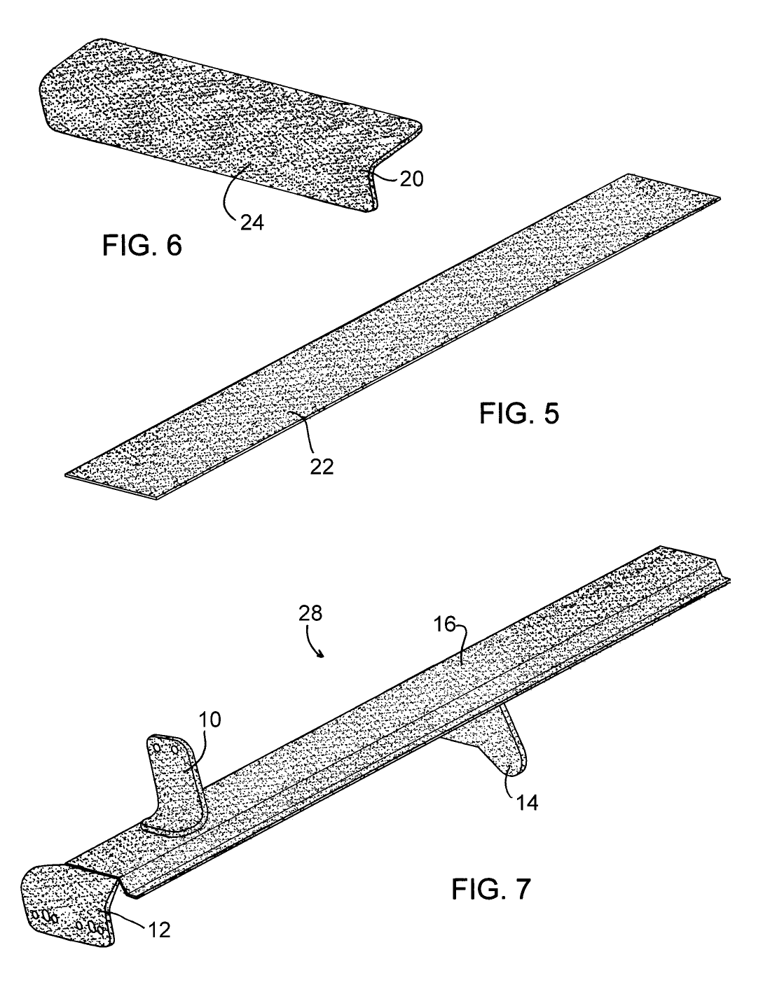

The present invention provides a process by which brackets that exhibit mechanical, chemical and thermal properties (including strength, fatigue resistance, maximum temperature capability, chemical/fluid resistance, etc.) that are suitable for aircraft engine applications and yet can be produced in a cost-effective manner. The invention involves producing components and/or subcomponents that are fabricated from PMC materials and undergo thermoforming to produce shaped panels that have what will be referred to as simple shapes. As used herein, a “simple shape” refers to a shape that can be formed from a single flat panel to have one or more bends that are present between portions of the shaped panel, and the shaped panel has a substantially constant cross-sectional thickness throughout its portions and bends. Three representative but nonlimiting examples of shaped panels that can be produced with this invention are shown in FIG. 1. The simple shapes of the panels avoid the difficulties and costs of producing complex unitary shapes from PMC materials. The cross-sectional thicknesses of shaped panels of this invention are typically within a range of about 0.5 to about 20 millimeters, and preferably do not vary by more than 30% of the panel thickness, and more preferably not more than 10% of the panel thickness (excluding any features that might be intentionally or unintentionally defined along the perimeter of a panel). Flat panels from which the shaped panels are formed (a nonlimiting example of which is represented in FIG. 5) also preferably have cross-sectional thicknesses that are substantially constant within the same ranges stated for the shaped panels.

Preferred PMC materials for use with this invention have a thermoplastic matrix material that is reinforced with continuous fibers, which may be individual fibers or fiber tows arranged parallel (unidirectional) within the matrix material, or individual fibers or fiber tows arranged to have multiple different orientations (e.g., multiple layers of unidirectional fibers or fiber tows to form a biaxial or triaxial architecture) within the matrix material, or individual fibers or fiber tows woven to form a mesh or fabric within the matrix material. The fibers, tows, meshes or fabrics can be arranged to define a single ply within the PMC or any suitable number of plies. Particularly suitable thermoplastic matrix materials include polyetheretherketone (PEEK), polyetherketoneketone (PEKK), polyetherimide (PEI) and polyphenylene sulfide (PPS), and particularly suitable continuous fiber materials include carbon (e.g., AS4), glass (e.g., S2), polymer (e.g., aramid, such as Kevlar®), ceramic and metal fibers. A preferred thermoplastic matrix material is believed to be PEEK, and a preferred reinforcement material is believed to be continuous carbon fibers. However, it is foreseeable that other suitable matrix and reinforcement materials could be used or later developed for use with the present invention. Suitable fiber contents for the PMC materials of this invention can vary widely, though it is believed that the fiber content should be at least 35 percent by volume and not more than 75 percent by volume, with a preferred range believed to be about 50 to about 65 percent by volume.

As noted above, processes of this invention generally start with a flat panel of the desired PMC material, for example, the flat panel 22 represented in FIG. 5. Various methods are known and could be used or developed to create the flat panel 22. One common form of raw material is known as prepreg, by which a reinforcement material is impregnated with a matrix material, in this case, the thermoplastic resin desired for the matrix material. Nonlimiting examples of processes for producing thermoplastic prepregs include hot melt prepregging in which the fiber reinforcement material is drawn through a molten bath of resin, and powder prepregging in which a resin is deposited onto the fiber reinforcement material (for example, electrostatically) and then adhered to the fiber (for example, in an oven or with the assistance of heated rollers). The prepregs can be in the form of unidirectional tapes or woven fabrics, which are then stacked on top of one another to create the number of stacked plies desire for the panel. The ply stack then preferably undergoes a consolidation operation, in which heat and pressure are applied to the ply stack to flow the resin and consolidate the ply stack into the flat panel 22. In addition to creating flat panels using prepreg, an alternative approach is lay up dry fabric in a suitably-shaped mold cavity and then infuse the dry fabric with molten resin. Regardless of how the flat panel 22 is manufactured, it is deemed to be flat if the entirety of its cross-section is defined between two opposite surfaces that lie in parallel planes to each other. Flat panels of this type will be referred to as lying in a single plane. The thickness of the flat panel 22 will vary depending on its intended use. However, as noted above, the cross-sectional thickness of the panel 22 preferably does not vary by more than 30% of the panel thickness.

The flat panel 22 is then thermoformed to define a shaped panel that has a simple shape (for example, as represented in FIG. 1). Thermoforming generally entails heating the flat panel 22 to a temperature at which its thermoplastic matrix material does not melt, yet is sufficiently pliable to allow the flat panel 22 to be shaped without damaging the materials of the flat panel 22. As a nonlimiting example, a suitable temperature for thermoforming a PMC flat panel containing PEEK as the matrix material and carbon fibers as the reinforcement material is generally in the range of about 350 to about 450° C. To reduce manufacturing costs, the simple shape of shaped panel is preferably common to multiple different bracket assemblies present in a gas turbine engine. As examples, such a shape might be a C or L channel (having a C-shaped or L-shaped cross-section) or variants thereof, for example, shapes having U- or V-shaped cross-sections. The shaped panels of FIG. 1 are representative of C-shaped channels that have been produced in accordance with this invention. However, it should also be noted that more complicated cross-sectional shapes are also possible. As noted above, a shaped panel is defined herein to have a simple shape if it can be formed from a flat panel to have one or more bends and a substantially constant cross-sectional thickness throughout its portions and bends. As non-limiting examples, each shaped panel of FIG. 1 has three portions connected by two bends to define a center portion defined by a central region of the original flat panel and second and third portions that lie in planes oriented at angles to the plane of the central region. While the second and third portions of each shaped panel in FIG. 1 were defined by thermoforming to lie in planes that are perpendicular to the plane of the central portion, the second and third portions could be oriented to be more than and less than ninety degrees from the plane of the center portion. It should be understood that a flat panel can undergo thermoforming to have more than two bends and more than three portions, yet still yield a shaped panel that can be deemed to have a simple shape.

If the process of producing a shaped panel involves the creation of a ply stack as described above, it is also within the scope of the invention to simultaneously consolidate and shape the ply stack to produce a shaped panel. For example, the ply stack can be fed into a thermoforming press, where the ply stack is simultaneously consolidated and thermoformed to yield the desired shape of the shaped panel (e.g., the shaped panels of FIG. 1).

FIG. 2 shows two subcomponents (or possibly two entire components) that were produced by machining two different shaped panels. Each subcomponent (and therefore the shaped panel from which it was machined) has an L-shaped cross-section in which two portions are oriented approximately ninety degrees to each other. As evident from FIG. 2, each component has a substantially constant cross-sectional thickness throughout its two portions and the bend therebetween. As will be appreciated from FIG. 2, the machining process preferably alters the shape of a panel without altering its cross-sectional shape. On the other hand, a subcomponent (or an entire component) can be produced that is a fragment of the original cross-sectional shape of its original shaped panel. For example, one of the shaped panels in FIG. 1 could be cut longitudinally to produce two or more subcomponents, each defining a fragment of the original cross-sectional shape of the shaped panel. As such, a single subcomponent or multiple individual subcomponents can be produced from a single shaped panel. Various methods can be used to machine a shaped panel of this invention, such as conventional machining, waterjet cutting, and laser cutting techniques. Of these, waterjet cutting techniques of types known in the art are believed to be preferred.

As should be evident from FIG. 2, either of the subcomponents shown could be used as a complete bracket, without the need for any further assembly with additional components. For example, each subcomponent of FIG. 2 could be machined to include holes, slots or other features with which a component, assembly, structure, etc., could be mounted to a gas turbine engine through the use of conventional mechanical fasteners and/or attachment mechanisms, for example, nut plates and spring clips that can be mounted to the bracket. On the other hand, subcomponents of the type represented in FIG. 2 could undergo further assembly to yield a larger and more complex bracket assembly. For example, the subcomponents could undergo a joining operation, such as through the use of mechanical fasteners (screws, bolts, rivets, etc.), an adhesive, or a thermoplastic welding technique, for example, infrared (IR) welding, resistive implant welding, ultrasonic welding, vibration welding, etc. While a bracket assembly can be constructed from subcomponents produced from different shaped panels, it is also within the scope of the invention that a single shaped panel could be machined to produce multiple subcomponents, which can then be assembled to produce a bracket assembly.

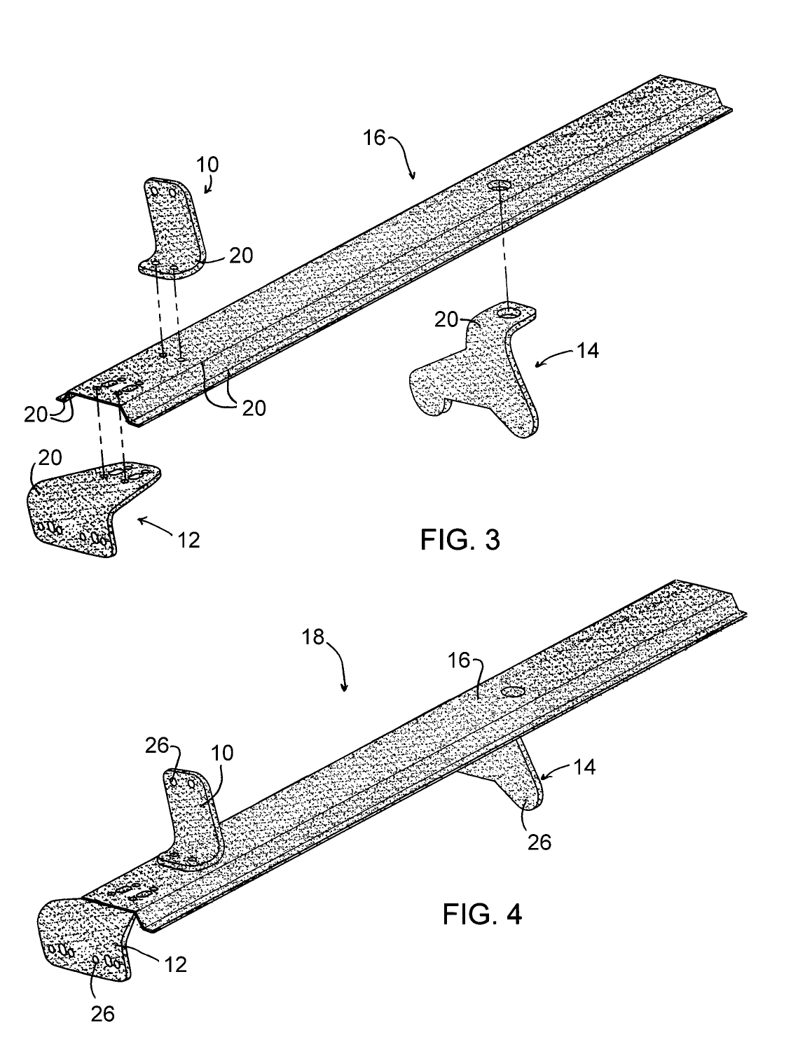

FIGS. 3 and 4 represent a nonlimiting example in which four separate subcomponents 10, 12, 14 and 16, each having a simple shape (FIG. 3), can be assembled with mechanical fasteners (for example, bolts) to yield a larger and more complex bracket assembly 18 (FIG. 4). In this example, each of the subcomponents 10, 12 and 14 has two portions separated by a single 90-degree bend 20, while the larger subcomponent 16 has five roughly parallel portions, with each adjacent pair of portions being separated by a bend 20 that defines an obtuse angle. Each subcomponent 10, 12, 14 and 16 can be readily produced as a PMC containing a continuous fiber reinforcement material as a result of its simple cross-sectional shape and constant cross-sectional thickness. In addition, each of the subcomponents 10, 12, 14 and 16 of FIG. 3 can be thermoformed and machined from a flat panel, for example, similar in appearance to the flat PMC panel 22 represented in FIG. 5. The larger subcomponent 16 of FIGS. 3 and 4 can be directly produced by thermoforming the flat panel 22 to have the four bends shown in FIG. 3, and then machining holes required for mechanically fastening the smaller subcomponents 10, 12 and 14 to the larger subcomponent 16. The smaller subcomponents 10, 12 and 14 can be fabricated by thermoforming another flat panel (which, in some cases, may be identical to the flat panel 22 of FIG. 5) to yield a shaped panel 24 having a single bend 20 as represented in FIG. 6, and then machining the panel 24 to form the individual subcomponents 10, 12 and 14 shown in FIG. 3. The subcomponents 10, 12 and 14 are formed to having features 26, such as holes and/or flanges, by which the assembly 18 can be mounted on an aircraft engine or by which one or more components, assemblies or other structures can be secured to an aircraft engine. It should be understood that, to maximize material utilization, it will often be advantageous to machine multiples of individual subcomponents 10, 12 and 14 from a shaped panel 24 that serves as a master part for that particular subcomponent 10, 12 or 14.

FIG. 7 shows a bracket assembly 28 that is made up of the very same subcomponents 10, 12, 14 and 16 shown in FIGS. 3 and 4, but differs as a result of the assembly 28 being held together as a result of the subcomponents 10, 12, 14 and 16 being joined together by a thermoplastic welding technique, thereby eliminating any need for the mechanical fasteners of FIG. 4.

While the invention has been described in terms of specific embodiments, it is apparent that other forms could be adopted by one skilled in the art. Therefore, the scope of the invention is to be limited only by the following claims.

1. A process comprising:
producing at least a first shaped panel that has a substantially constant cross-sectional thickness and has at least first and second portions that lie in different planes and are interconnected by at least a first bend therebetween, the first shaped panel being formed by thermoforming a polymer matrix composite material comprising a thermoplastic resin reinforced with a continuous fiber reinforcement material;
machining the first shaped panel to alter the shape thereof, wherein the machining step directly produces a load-bearing bracket from the first shaped panel, or the machining step produces at least a first subcomponent from the first shaped panel and then the first subcomponent undergoes a joining operation to form a load-bearing bracket, or the machining step produces multiple separate subcomponents from the first shaped panel and then at least some of the multiple separate subcomponents undergo a joining operation to form a load-bearing structure; and
installing the load-bearing structure on an aircraft engine.

2. The process according to claim 1, wherein the thermoplastic resin is chosen from the group consisting of polyetheretherketone, polyetherketoneketone, polyetherimide, and polyphenylene sulfide, and the continuous fiber reinforcement material is chosen from the group consisting of carbon, glass, polymer, ceramic and metal fibers.

3. The process according to claim 1, wherein the machining step directly produces the load-bearing structure from the first shaped panel.

4. The process according to claim 1, wherein the machining step produces at least the first subcomponent from the first shaped panel, the first subcomponent undergoes the joining operation with a second subcomponent to form the load-bearing structure, and the second subcomponent has a substantially constant cross-sectional thickness and is formed of a polymer matrix composite material comprising a thermoplastic resin reinforced with a continuous fiber reinforcement material.

5. The process according to claim 1, wherein the machining step produces the multiple separate subcomponents from the first shaped panel and then at least two of the multiple separate subcomponents undergo the joining operation to secure the at least two multiple separate subcomponents together to form the load-bearing structure.

6. The process according to claim 1, wherein the process comprises the joining operation to form the load-bearing structure, and the joining operation comprises a thermoplastic welding process and/or using one or more mechanical fasteners to secure the load-bearing structure together.

7. The process according to claim 1, wherein the first shaped panel has a cross-sectional shape chosen from the group consisting of C-, U-, L- and V-shaped cross-sections.

8. The process according to claim 1, wherein the first shaped panel further comprises at least a third portion that lies in a different plane than the first and second portions of the first shaped panel and is interconnected to at least one of the first and second portions by at least a second bend.

9. The process according to claim 1, wherein the producing step comprises:
producing a first flat panel from multiple plies of the polymer matrix composite material to have a substantially constant cross-sectional thickness and lies in a single plane; and then
thermoforming the first flat panel to produce the shaped panel.

10. The process according to claim 1, wherein the producing step comprises simultaneously consolidating and thermoforming multiple plies of the polymer matrix composite material to produce the shaped panel.

11. The load-bearing structure produced by the process of claim 1.

12. A process comprising:
producing at least first and second flat panels of a polymer matrix composite material comprising a thermoplastic resin reinforced with a continuous fiber reinforcement material, each of the first and second flat panels having a substantially constant cross-sectional thickness and being flat so as to lie in a single plane;
thermoforming at least one of the first and second flat panels to form at least a first shaped panel that has a substantially constant cross-sectional thickness and has at least first and second portions that lie in different planes and are interconnected by at least a first bend therebetween;
machining the first shaped panel to alter the shape thereof and produce at least a first subcomponent therefrom;
joining the first subcomponent to at least a second subcomponent defined by the second flat panel or formed by thermoforming the second flat panel, the joining step producing a load-bearing bracket; and then
installing the load-bearing bracket on an aircraft engine so as to secure a component to the aircraft engine.

13. The process according to claim 12, wherein the thermoplastic resin is chosen from the group consisting of polyetheretherketone, polyetherketoneketone, polyetherimide, and polyphenylene sulfide, and the continuous fiber reinforcement material is chosen from the group consisting of carbon, glass, polymer, ceramic and metal fibers.

14. The process according to claim 12, wherein the joining step comprises a thermoplastic welding process and/or using at least one mechanical fastener to secure the first and second subcomponents together.

15. The process according to claim 12, wherein the shapes of the first and second shaped panels are chosen from the group consisting of C-, U-, L- and V-shaped cross-sections.

16. The process according to claim 12, wherein the shape of the first shaped panel further comprises at least a third portion that lies in a different plane than the first and second portions of the shaped panel and is interconnected to at least one of the first and second portions by at least a second bend.

17. The process according to claim 12, wherein the first and second flat panels are identical prior to the step of thermoforming the first and second shaped panels.

18. The process according to claim 12, wherein the machining step produces a plurality of the first subcomponent from the first shaped panel.

19. The load-bearing bracket produced by the process of claim 12.

20. An aircraft engine bracket formed of a polymer matrix composite material comprising a continuous fiber reinforcement material in a polymer resin matrix material.

21. The aircraft engine bracket according to claim 20, wherein the polymer resin matrix material is a thermoplastic resin matrix material.

22. The aircraft engine bracket according to claim 20, wherein the bracket consists of at least one machined shaped panel formed of the polymer matrix composite material, means for securing the bracket to an aircraft engine, and means for mounting at least one component to the aircraft engine.

23. The aircraft engine bracket according to claim 22, wherein the at least one machined shaped panel consists of one machined shaped panel.

24. The aircraft engine bracket according to claim 22, wherein the at least one machined shaped panel comprises at least two machined shaped panels that are joined together.

25. The aircraft engine bracket according to claim 22, wherein the at least one machined shaped panel has a substantially constant cross-sectional thickness and has at least first and second portions that lie in different planes and are interconnected by at least a first bend therebetween.

26. The aircraft engine bracket according to claim 25, wherein the at least one machined shaped panel has a cross-sectional shape chosen from the group consisting of C-, U-, L- and V-shaped cross-sections.

27. The aircraft engine bracket according to claim 25, wherein the at least one machined shaped panel further comprises at least a third portion that lies in a different plane than the first and second portions thereof and is interconnected to at least one of the first and second portions by at least a second bend.

28. The aircraft engine bracket according to claim 22, wherein the at least one machined shaped panel is produced by consolidating and thermoforming multiple plies of the polymer matrix composite material.

29. The aircraft engine bracket according to claim 22, wherein the bracket is mounted on an exterior of a fan casing of an aircraft engine and secures a component to the fan casing.

30. An aircraft engine bracket comprising at least first and second subcomponents that are joined together to form the bracket, each of the first and second subcomponents being formed of a polymer matrix material comprising a continuous fiber reinforcement material in a thermoplastic resin matrix material, each subcomponent having a substantially constant cross-sectional thickness, at least one of the subcomponents being machined from at least one shaped panel that was thermoformed to have a substantially constant cross-sectional thickness and at least first and second portions that lie in different planes and are interconnected by at least a first bend therebetween.

31. The aircraft engine bracket according to claim 30, wherein the thermoplastic resin matrix material is chosen from the group consisting of polyetheretherketone, polyetherketoneketone, polyetherimide, and polyphenylene sulfide, and the continuous fiber reinforcement material is chosen from the group consisting of carbon, glass, polymer, ceramic and metal fibers.

32. The aircraft engine bracket according to claim 30, wherein each of the first and second subcomponents has a cross-sectional shape chosen from the group consisting of C-, U-, L- and V-shaped cross-sections.

33. The aircraft engine bracket according to claim 30, wherein at least one of the first and second subcomponents further comprises at least a third portion that lies in a different plane than the first and second portions thereof and is interconnected to at least one of the first and second portions by at least a second bend.

34. The aircraft engine bracket according to claim 30, wherein at least one of the first and second subcomponents is produced by consolidating and thermoforming multiple plies of the polymer matrix composite material.

35. The aircraft engine bracket according to claim 30, wherein the bracket is mounted on an exterior of a fan casing of an aircraft engine and secures a component to the fan casing.
